(19) United States
(12) Patent Application Publication
(10) Pub. No.: US 2008/0155547 A1
(43) Pub. Date: Jun. 26, 2008

(54) Transactional calendar

(75) Inventors: Karon A. Weber, San Francisco, CA (US); Liang-Yu Chi, San Francisco, CA (US); Samantha M. Tripodi, San Francisco, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/644,812

(22) Filed: Dec. 22, 2006

(51) Int. Cl. G06F 9/46

(52) U.S. Cl. 718/102

(57) ABSTRACT

A transactional calendar can be used to interact with online services that perform any type of tasks. The calendar's user interface has features for choosing a service to invoke. When the calendar invokes the service, information such as the date and time currently selected on the calendar is automatically passed to the service in a defined data format. Upon completing a task, the service returns the result to the calendar in a defined format, and a calendar entry is made for the task. The calendar entry can be used to view details about the task. A calendar-based user interface allows a user to view and interact with pending and completed tasks being performed by disparate online services. The transactional calendar may automatically generate inferred tasks in response to user-created tasks.

### BACKGROUND OF THE INVENTION

1. Field of the Invention

The present invention relates generally to online services, and more specifically to calendar-based techniques for interacting with online services.

2. Description of the Related Art

Online services such as travel reservation systems, online stores, online banking services, and the like allow users to conduct many business and personal tasks on a computer. The services are often independent, and data such as dates is typically entered separately into each service.

Information about tasks performed using online services, such as web-based or web-service systems including banking services, travel reservation services, event scheduling services, or any other services that provide an online interface, is often stored in email messages, or stored separately on each online service. For example, a confirmation of a purchase from an online store would typically be stored in an email message. The date of the purchase, the expected delivery date, and other information about the purchase task are stored in an email message that is typically presented using an email user interface which displays numerous email messages about different topics. A user may categorize the messages by saving them to appropriate folders based on their content. If the user wishes to display task confirmations received as email messages on an electronic calendar, such as Yahoo!® Calendar or Microsoft® Outlook®, then the user typically must enter the task dates and other information into the calendar manually. Microsoft® Outlook® allows users add information in special types of email messages, such as meeting invitations, to their calendar. However, Outlook® meeting requests do not typically interoperate with online services. Airline reservation web sites and online travel reservation web sites, such as the Southwest Airlines® web site, provide services for making travel reservations online, but the reservation information is provided to the user as an electronic mail message.

The Yahoo!® Flickr® photo sharing service has a feature for viewing photos by date. This feature displays a user's photographs on a calendar. Some banking web sites allow users to view their tasks on a calendar. A bank calendar display may show, for example, a user's pay day and the day that a user's rent is to be paid. However, each online service's calendar is typically separate from calendars provided by other online services. If a user wishes to view the photos and the financial tasks on a single calendar, the user typically must manually enter the information from multiple services, such as the photos and the financial tasks, into the single calendar.

Therefore it would be desirable to be able to store and access the results of online tasks from a common interface that would be able to organize the results automatically.

### SUMMARY OF THE INVENTION

In general, in a first aspect, the invention features a computer-enabled method of adding a task to an online calendar. The method includes the steps of receiving selection of a date from a user of the online calendar, receiving selection of a task type from the user, and adding a calendar entry to the online calendar, wherein the calendar entry includes the date and the task type. Embodiments of the invention may include one or more of the following features. The method may further include the steps of sending a request to a server to execute an operation based upon the task type and the date; where the server is selected based upon the task type and the request includes the task type and the date record, receiving a response from the server; where the response includes a result, and adding the result to the calendar entry. The response may include a link to a web page associated with the task, and the method may include the step of adding the link to the calendar entry. The method may further include the steps of generating an inferred task based upon a rule, where the rule is chosen based upon the task type and the date, and where the rule generates the inferred task based upon the task type and the date, and adding the inferred task to the calendar. The difference between a first time value at which the inferred task occurs and a second time value included in the date may be less than a predetermined threshold.

In general, in a second aspect, the invention features transactional calendar, which includes a calendar day feature for displaying a calendar, where the calendar day feature comprises an add task feature for creating a new task, and the calendar day feature is operable to display a calendar entry that represents an existing task, date selection logic for receiving selection of a selected calendar date, task selection logic for receiving selection of a task type and a task option parameter for the task type, task record generation logic for generating a task record, wherein the task record is based upon the task type, the calendar date, and the task option parameter, and task submission logic for sending the task record to an online service. Embodiments of the invention may include one or more of the following features. The transactional calendar may further include update receiving logic for receiving a task processing update, where the task processing update comprises a task record, and wherein the task record comprises a date and a completion status, and update display logic for displaying the completion status in the calendar entry, where the update display logic is operable to display the task processing update in the calendar entry. The task processing update may include a link to a web page for the task, and wherein the update display logic may be operable to display the link in the calendar entry as a hyperlink to the web page. The task record further may include security credentials of the user.

In general, in a third aspect, the invention features a computer-enabled method of updating an online calendar with information describing a task, in response to execution of the task by an online service. The computer-enabled method includes the steps of receiving a task record from the online service, where the task record includes a task date, and adding a calendar entry to the online calendar, where the calendar entry is associated with a calendar date associated with the online calendar, the calendar date is based upon the task date, and the calendar entry includes a description of the task. Embodiments of the invention may include one or more of the following features. The task date may include a date of execution of the task, a date of a reservation referenced by the task, or a combination thereof. The task record may include a completion status, and the method may include the step of: adding the completion status to the calendar entry, where the completions status comprises a pending status and a completed status. The date may specify the time of completion of the task.

In general, in a fourth aspect, the invention features a computer-enabled method of updating an online calendar with information describing a task, in response to execution of the task by an online service. The method includes the steps of retrieving a task result from the online service, searching the task result for a completion status and a date, and adding the completion status and the date to the online calendar if the completion status and the date are found in the result. Embodiments of the invention may include the following feature: searching the task record may include searching the task record for a text pattern.

In general, in a fifth aspect, the invention features a computer-enabled method of updating an online calendar with information describing a task, in-response to execution of the task by an online service. The method includes the steps of receiving a task record from the online service, and adding an entry to the online calendar, where the entry includes a date, a task type, and a result extracted from the task record. Embodiments of the invention may include the following feature: the method may be executed by a toolbar component of a client browser.

In general, in a sixth aspect, the invention features a computer-readable medium comprising instructions for adding a task to an online calendar, the instructions for causing performance of a method. The method includes the steps of receiving selection of a date from a user of the online calendar, receiving selection of a task type from the user, and adding a calendar entry to the online calendar, where the calendar entry includes the date and the task type. Embodiments of the invention may include one or more of the following features. The method may further include the steps of sending a request to a server to execute an operation based upon the task type and the date, where the server is selected based upon the task type and the request includes the task type and the date; receiving a response from the server; where the response includes a result, and adding the result to the calendar entry. The method may further include the steps of generating an inferred task based upon a rule, wherein the rule is chosen based upon the task type and the date, and the rule generates the inferred task based upon the task type and the date, and adding the inferred task to the calendar. The difference between a first time value at which the inferred task occurs and a second time value included in the date may be less than a predetermined threshold.

### BRIEF DESCRIPTION OF THE DRAWINGS

FIG. 1A is an illustrative drawing of a system for providing a transactional calendar in accordance with some embodiments of the invention.

FIG. 1B is a schematic drawing of an illustrative client server system that can run a novel process for providing a transactional calendar in accordance with some embodiments of the invention.

FIG. 2 is an illustrative diagram of a task record being sent from a calendar to an online service in accordance with some embodiments of the invention.

FIG. 3 is an illustrative diagram of a task record being sent from an online service to a calendar in accordance with some embodiments of the invention.

FIG. 4 is an illustrative block diagram of a task record format in accordance with some embodiments of the invention.

FIG. 5 is an illustrative diagram of a transactional calendar user interface in accordance with some embodiments of the invention.

FIG. 6 is an illustrative diagram of a user interface for invoking a car rental service from a transactional calendar in accordance with some embodiments of the invention.

FIG. 7 is an illustrative diagram of a car rental service user interface showing dates provided by a transactional calendar in accordance with some embodiments of the invention.

FIG. 8 is an illustrative diagram of a transactional calendar user interface showing a calendar item automatically made in response to a car reservation task in accordance with some embodiments of the invention.

FIG. 9 is an illustrative flow diagram of a process in which a transactional calendar invokes an online service and is automatically updated based on the results in accordance with some embodiments of the invention.

FIG. 10 is an illustrative flow diagram of a process in which a user invokes an online service and the transactional calendar is automatically updated based on the results in accordance with some embodiments of the invention.

FIG. 11 is an illustrative drawing of an exemplary computer system that may be used in accordance with some embodiments of the invention.

### DETAILED DESCRIPTION OF THE INVENTION

The following description is presented to enable any person skilled in the art to make and use the invention, and is provided in the context of particular applications and their requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

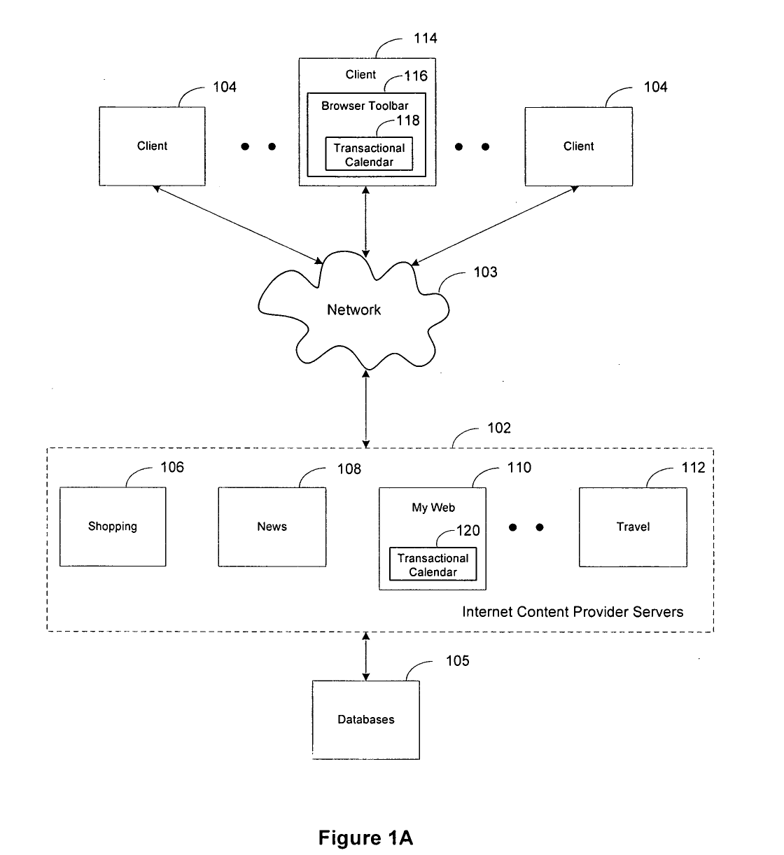

FIG. 1A is an illustrative drawing of a system for providing a transactional calendar in accordance with some embodiments of the invention. The system includes one or more Internet content provider servers 102, databases 105, and one or more clients 104, 114. The servers 102 interface with the clients 104, 114 via a communication network 103. The Internet content provider servers 102 are host servers operable to provide content to clients 104, 114 via the network 103. One or more of the servers host websites and include the map functions. The databases 105 are operable to store data provided by the servers 102 and by the clients 104, 114. The databases can communicate with the servers 102 or clients 104, 114 via the network 103. The databases can store data items included in the web pages, such as maps and user information.

Alternatively, the servers 102 may include the databases, processors, switches, routers, interfaces, and other components and modules. Each of the servers 102 may comprise one or more servers, or may be combined into a lesser number of servers than shown, depending on computational and/or distributed computing requirements. The servers 102 may be located at different locations relative to each other. The databases may also be separately connected to the servers 102. There may be more or fewer than two databases, depending on computational and/or distributed computing requirements. The databases may be located at different locations relative to each other and the servers 102.

Each of the clients 104, 114 may be a general-purpose computer, such as a personal computer, having a central processing unit (CPU), a memory, an input device, an output device, and a display. Other computer system configurations, including Internet appliances, hand-held devices, wireless devices, portable devices, wearable computers, cellular or mobile phones, portable digital assistants (PDAs), multi-processor systems, microprocessor-based or programmable consumer electronics, set-top boxes, network PCs, mini-computers, and the like may also be implemented as the clients 104, 114. Each of the clients 104, 114 may also implement analog and digital baseband circuitry, power management circuitry, radio frequency (RF) transceiver, and battery interface and charging circuitry. The clients 104, 114 may include one or more applications, program modules, and/or sub-routines. As an example, the clients 104, 114 may include a browser application (e.g., Internet Explorer™ or the like, not shown) and a graphical user interface (GUI) to access websites and web pages provided by the servers 102 and data stored at the databases 105. The clients 104, 114 may be remote from each other, from the servers 102, and from the databases 105. The network 103 is a communications network, such as a local area network (LAN), a wide area network (WAN), or the Internet. When the network 103 is a public network, security features (e.g., VPN/SSL secure transport) may be included to ensure authorized access within the system.

The servers 102 further include a plurality of individual domains, for example, a shopping domain 106, a news domain 108, a My Web domain 110, a Travel domain 112, and the like. A domain is a computer system implemented with different hardware and software for a specific application, such as the shopping applications, news applications, and maps applications.

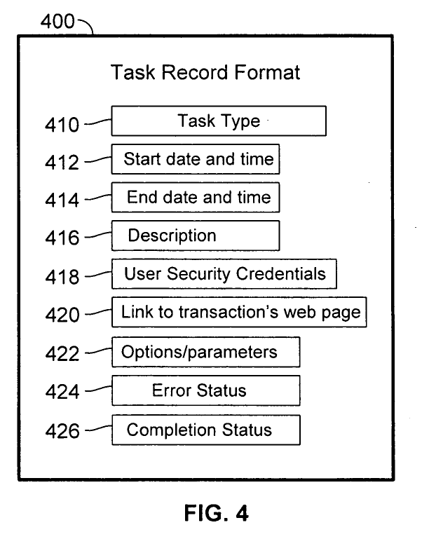

In one aspect, the transactional calendar includes a calendar-based user interface for interacting with the servers 102, as shown in FIGS. 5-8. For example, the transactional calendar may allow a user to select a date from a calendar, and then pass the date to the news domain 108 to execute a query for new items on that date. That is, a user may execute a query for news items from a calendar-based user interface. As another example, when an item is purchased in the shopping domain 106, information about the purchase task, including the purchase date, may be used by the transactional calendar to create calendar entries representing the purchase date and the expected delivery date.

The transactional calendar may be implemented by either the client 114, by a service such as My Web 110, or by a combination of both. A client-side transactional calendar 118 may be implemented by or invoked by a browser toolbar 116 that interacts with the browser application. The browser toolbar runs on the same device or computer as the browser, and has access to the content that is passed to and from the browser. The browser toolbar may be, for example, the Yahoo!® Toolbar. The client-side transactional calendar 118 and the browser toolbar 116 may run on the client 114 and may be implemented using a programming language such as JavaScript™, C, C++, or the like in combination with World Wide Web features such as HTML, CSS, and HTTP. In another aspect, a server-side transactional calendar 120 may be run on My Web 110, which implements Web 2.0 functionalities using a combination of HTML, CSS, JavaScript™, Widget Engine, and “Asynchronous JavaScript and XML” (AJAX). In one aspect, if the transactional calendar 118 is run from a toolbar, then the transactional calendar's user interface will be displayed in an overlay plane that overlays content being displayed in a web browser. The transactional calendar overlay then disappears when appropriate, e.g., when closed by a user. In another aspect, if the transactional calendar 118 is run from a web-based application such as My Web, the transactional calendar's user interface would be displayed as web content, such as a web page that shows a calendar-based view of a user's tasks.

FIG. 1B is a schematic drawing of an illustrative client server system that can run a novel process for providing a transactional calendar in accordance with some embodiments of the invention. A client 130 communicates with a server A 140 and a server B 120 via a network in a system as shown in FIG. 1A. The client 130 corresponds to the clients 104 of FIG. 1A. Server A 140 corresponds to the content provider servers 102 of FIG. 1A, such as the Shopping domain 106, the News domain 108, and the Travel domain 112. That is, server A provides an online service. Server B 120 corresponds to the My Web domain 110 of FIG. 1A. Server B 120 provides a transactional calendar 122.

FIG. 1B illustrates two methods in which users may define tasks. The term task, as used herein, refers to any action to be performed. A task may be a task, such as a financial task, an item on a to-do list, a request for work to be performed, or any other type of action. In the first method for defining tasks, referred to as case (a), the user interacts with a calendar interface (shown in FIG. 5) to define a task. The calendar interface in turn submits the task to the online service 162, which executes the task and returns the task result back to the transactional calendar 122. In the second case, referred to as case (b), the user interacts with the online service 162 to define a task, and the online service 162 executes the task and returns the result to the transactional calendar 122. In both cases, the task result is returned to the calendar 122, and the calendar 122 may create a calendar entry (not shown) on the appropriate date. The calendar entry may be, for example, a link to a web page that shows a more detailed description of the task. The detailed description may also include a link to a content page provided by the online service 162 for the task, such as a web page describing a reservation or purchase order task.

In case (a), the user selects a date from the calendar interface of FIG. 5 and then specifies the type of task and any options, i.e., input values, for the task. The calendar in turn requests that the online service 164 perform the task. When the service responds that the task is compete or has failed, the calendar is updated accordingly to show the task result in the calendar entry associated with the task.

In one aspect, the transactional calendar 122 displays status of tasks in progress by displaying tasks related to the task as they occur. That is, “child” tasks that occur during the execution of a task may be displayed in the transactional calendar 122. These child tasks may be linked to their parent task by, in one example, a link to the parent task's web page. The link to the parent's web page may appear on a web page that describes the child task. For example, if a user buys a rug from an online vendor on Saturday, a calendar entry will be created in the user's calendar for the task receipt. On Tuesday, when the vendor ships the rug, the transactional calendar adds a task to the user's calendar stating that the rug has been shipped. On Wednesday, the shipper places the rug on a truck. Every day, the transactional calendar can show the user where the rug is as it makes its way to its destination. The transactional calendar displays these child tasks as a result of the rug purchase task on Saturday. Once the rug is delivered to the user, the transit data is stored under the original task.

In more detail, in case (a), a user first accesses a calendar interface, such as a graphical representation of a month, week, or day (e.g., as shown in FIG. 5) in a web browser 132 running on the client 130. The calendar interface appears on a web page displayed by the client 130, and is generated by the transactional calendar 122. The calendar interface provides an option which the user can select to “Add” a task on a date that the user chooses. The user also selects a type of task to add, by, for example, selecting an online service from a list, and selecting a specific task provided by the service. For example, when adding a task, the transactional calendar 122, or a related component, may present a list of online services that include Shopping, News, and Travel. If the user selects the Travel service, a list of task types available for the Travel service will be displayed, such as Make Airline Reservation, Make Rental Car Reservation, Make Hotel Reservation, and the like. If the user selects a particular task type from the list, then the transactional calendar 122, or a related component, will generate a web page or similar document that includes input fields for which the user can enter values of task details 134, such as options, e.g., a type of car to be rented. The date portion of the task details 134 is automatically set, i.e., filled in, by the transactional calendar, using the date that the user chose when invoking the “Add” task option. The task type is similarly filled in automatically based on the type that the user selected. The task type and date fields of the task details 134 may be changed by the user, but, by default, the user only provides values for them once, i.e., when invoking the “Add” task option. The task details 134 may include optional credentials, which typically include information, such as a user name and password, for authenticating the user.

In case (a), the transactional calendar forwards the task details 134 to server A 140 running the selected online service. That is, the transactional calendar 122 acts as an intermediary between the client 130 and server A 140. For example, the client 130 may be a web browser that accesses the transactional calendar 122, and selects a command in the transactional calendar, such as creating a task associated with a specified date. The transactional calendar then communicates with server A 140 to perform the command. The task details 134 may be sent to server A 140 in a task record 138 or in some other data format.

When the user has finished entering values for the task details 134, the user submits the details 134 to the transactional calendar 122. The user typically submits the details by selecting a user interface feature such as a button labeled Submit. The task details 134 are then sent from the client 130 to server B 120 via the network, as shown by an arrow 144. The arrow 144 indicates HTTP communication, although other communication protocols may also be used. On server B 120, the values are received by the transactional calendar 122, which creates a task record 124 that contains the values. The transactional calendar may also verify the credentials of the task details 134 received from the browser 132. The transactional calendar 122 includes user credentials 126, which may be used to verify that the task details 134 have been received from a legitimate user. The credential verification may be performed by comparing the user credentials 126 to the credentials in the task details 134 received from the client 130.

The transactional calendar 122 next invokes the online service 162 by sending the task record 138 to the service 162 via the network, as shown by the arrows 146 and 150 from server B to server A. The task record 138 contains the values generated by server B 120, which are shown as an internal task record 124. The task record 138 is typically serialized into a stream of bytes for transmission across a network.

The transactional calendar 122 and the online service 162 may run on the same server, in which case the task record may be sent using an inter-process communication protocol. As another alternative, the transactional calendar 122 and the online service 162 may be more closely integrated, in which case intra-application communication may be possible. That is, the task record 124 may be sent to the service 162 using intra-process communication. In one aspect, the client-provided task details 134 may be sent to the service 162 in other formats, without conversion to a task record 138.

When the online service 162 receives task details 164, either in the form of the task record 138 or in some other form, the task specified by the task details 164 is performed, and the result is returned to the transactional calendar as shown by the arrows 152 and 148. The result is typically returned to the transactional calendar 122 using the same communication method, e.g., network or inter-process communication, as was used to send the task record 138 to the service. When the transactional calendar 122 receives the result of the service invocation, a calendar entry may be created, or an existing calendar entry may be updated, to reflect the status of the service invocation. The status is typically either a success status, in which case a “Done” entry is made in the calendar indicating that the operation is done, or an error status, in which case a “Failed” entry may be made in the calendar indicating that the operation failed. In summary, as a result of the user's use of the transactional calendar 122 to invoke a task in a service, the results of the task are added to the transactional calendar 122.

In case (b), the client 130 invokes the service 162 directly, and passes the task details 134 to the service 162. The service 162 then informs the transactional calendar 122 of the task by passing a task record 138 containing the task details 134 to the transactional calendar 122. For example, the client 130 may use a web browser 132 that directly accesses a web page provided by a web server running on server A 140. In this case, the task details 134 are sent from the client 130 to server A 140 via the network, as shown by an arrow 142. The client 130 may send the task details 134 to the service 162 in any data format, e.g., as an HTTP request, or as a task record. The arrow 142 indicates HTTP communication, although other communication protocols may also be used. After server A 140 receives the task details 164 from the client 130, the process continues as in case (a), with server A 140 passing a task record 138 to the transactional calendar 122.

In some embodiments, transactional metadata in the task record 138, such as prices, ticket information, and the like, may be extracted from an electronic mail message. In that way, the transactional calendar 122 may create a calendar entry for a transaction task based on an transactional metadata in an electronic mail message. Similarly, the transactional calendar 122 may generate electronic mail message representations of transaction tasks, so that information about transactions can be sent via email to people who are not users of the transactional calendar.

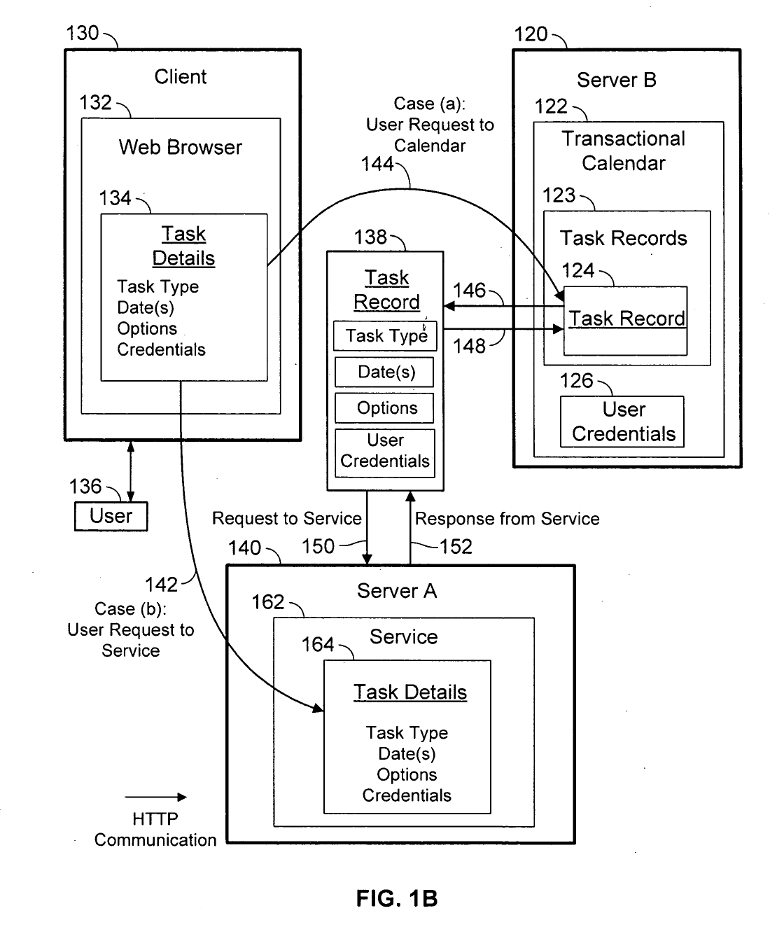

FIG. 2 is an illustrative diagram of a task record being sent from a calendar to an online service in accordance with some embodiments of the invention. The task record 208 corresponds to the task record 138 sent from the transactional calendar 122 to the service 162 in FIG. 1B. The task record 208 represents a request for service sent from a transactional calendar 202 to a service 204. When a task is created by the transactional calendar 202 as described in case (a) above, the calendar 202 generates and sends a task record 208 to the online service 204.

In one aspect, the task record 208 essentially comprises a data structure encoded in a computer-readable medium. The task record 208 includes data values that describe a particular task. The task record 208 typically conforms to a standard format that has been defined to allow task information to be exchanged between different programs running on applications and online services. The task record 208 conforms to a defined data format that allows exchange of task information between the transactional calendar 202 and online services 204. The online service 204 and the transactional calendar 202 may be provided by two separate parties or organizations, and may be running on two separate computers or servers.

The task record 208 may include a task type 216, a date 218, options 220, and user credentials 222. These values are provided by the transactional calendar 202 when it creates the task record 208. The task type 216 indicates the type of the task, which may be, for example, a purchase order, a credit card payment, a ticket purchase, an airline reservation, or any other type of task. Depending on the type of the task, particular values will be present in the options 220. For example, for a purchase order task, the options 220 may include an item type, a price, and a shipping address. For a credit card payment, the options 220 may include an account number and a payment amount. For a reservation, the options 220 may include the name of the person requesting the reservation and the requested date(s) of the reservation.

The date 218 typically includes dates that are relevant to many different types of tasks, such as the date on which the task was requested. The date 218 may also include additional dates, such as a completion date. The user credentials 222 are typically security credentials, such as a user name or user identifier, and a password, for the user on whose behalf the task record 208 was generated.

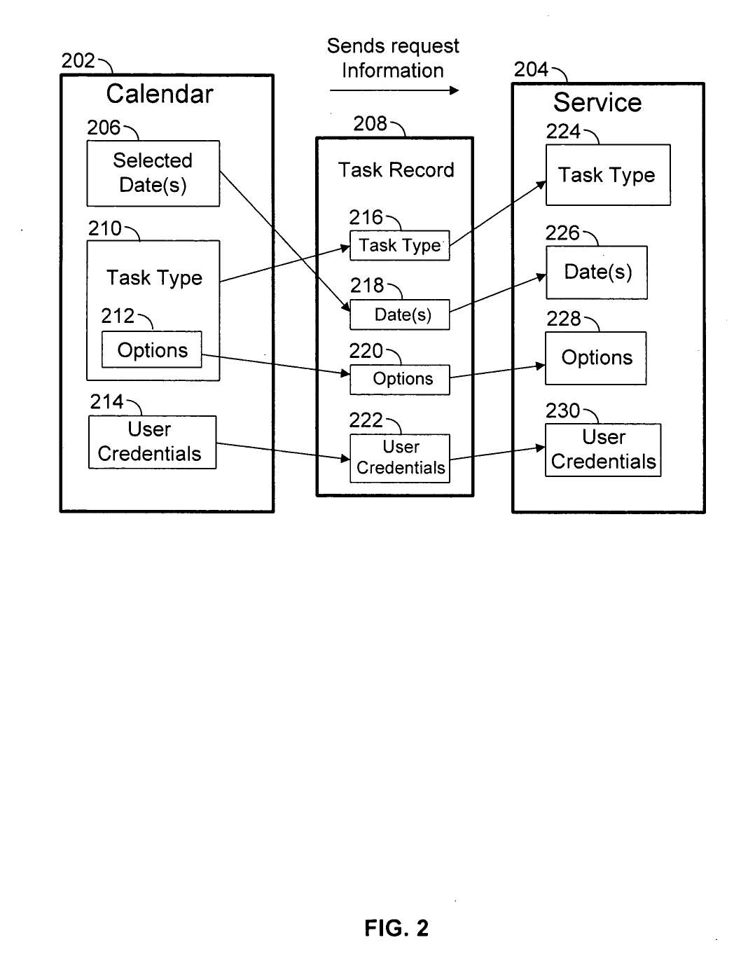

FIG. 3 is an illustrative diagram of a task record being sent from an online service to a calendar in accordance with some embodiments of the invention. The task record 308 corresponds to the task record 138 sent from the service 162 to the calendar 122 in FIG. 1B.

The task record 208 corresponds to the task record 138 sent from the transactional calendar 122 to the service 162 in FIG. 1B. The task record 308 represents a response or an asynchronous update sent by a service 204 sent to a transactional calendar 202. When a task is created by the online service 204, as described in case(b) above, the online service 204 generates a task record 208 and sends the task record 208 to the transactional calendar 202. The transactional calendar 202 may then create a calendar entry for the task in a displayed rendition of the transactional calendar. The displayed rendition may be, for example, a month display showing the days of a month on a grid, as described below with respect to FIG. 5. The calendar entry is typically displayed on the calendar as a link that includes a textual description of the task. The textual description appears in association with the task's date. For example, a calendar entry for payment of an electric bill on June 20 would appear in a box or area that represents the 20th day of June. The link may be, for example, a link to web content that shows a more detailed description of the task.

While the task record 308 may contain data values similar to those in the task record 208 of FIG. 2, the task record 308 is typically sent as a response from the service 204, and response includes values generated by the service 204, such as a confirmed reservation date produced by a travel registration service. The service 204 may also send the task record 308 to the calendar 202 at asynchronously, i.e., not in response to a request, to provide information to the calendar 202 whenever the information becomes available. The task record 208 includes request values generated by the calendar 202, such as a requested reservation date received from a user. The response task record 308 may also includes a success or failure indicator, which indicates whether the requested task was successfully processed by the service 204. Some of the values, such as the options 220 of the request or the options 320 of the response task record 308, may be absent. The sender of each task record 208,308 may fill in only the values applicable. For example, if the service 204 approves a reservation requested for a particular date, then the service 204 may send a response task record 308 that does not contain a date 318.

If the requested task was not successfully processed, then the task record 308 may include an error status 323, which, if present, would indicate that an error has occurred while the service 204 was processing the request. The error status 323 may include an error code value and an error description indicating the reason for the failure.

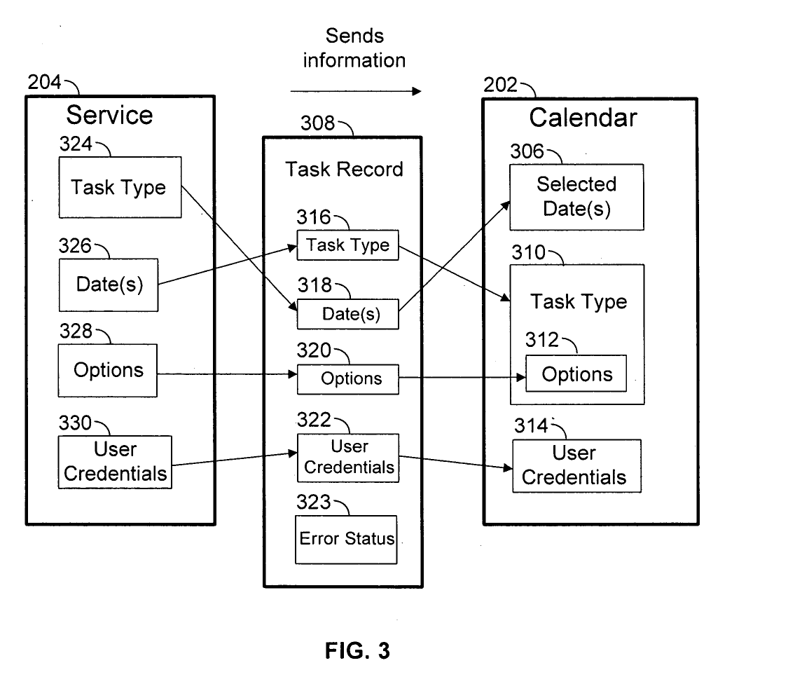

FIG. 4 is an illustrative block diagram of a task record format 400 in accordance with some embodiments of the invention. The task record format 400 is an extension of the task record 138 of FIG. 1B. The task records 138 would typically include more information than shown in FIG. 1B. Some of the additional information that may be included is shown in the task record format 400. In particular, a description 416 and a link 420 to a task's web page may be included in task records. The description 416 is typically a human-readable description of the task. The link 420 is typically a link generated by the service 204. The link 420 is a link to a web page hosted by the service 204. The web page may provide details about the task, and may allow the user to modify or cancel the task. For example, for a travel reservation, the link 420 may be a web link to a web page that provides information about the reservation, and provides options for viewing, updating, and canceling the reservation. The other fields of the task record format are generally similar to the fields previously described of task records 138,208,308. In particular, the task record format may include a task type 410, a start date and time 412, an end date and time 414, a description 416, user security credentials 418, a link 420 to a web page for the task, options 422, an error status 424, and a completion status 426. The error status 424 indicates whether the service encountered an error processing the task. If an error was encountered, the error status 424 describes the type of error. The completion status 426 indicates whether the task is complete, started and pending, or not started, i.e., occurs in the future.

For example, a task record 138 that represents an airline reservation request may be represented in the following format:

BEGIN:TASKRECORD
VERSION:1.0
START:20061125
END:20061127
DESCRIPTION:ExampleFlightReservation
CREDENTIALS:XX3320F
LINK:www.yahoo.com/services/flightreservations/XYZ123
REQUESTEDAISLE:inside
FREQUENTFLYER:332533
END:TASKRECORD.

In one aspect, a task record format 400 may be any data format that can be used by a sender to encode a particular type of data and by a receiver to decode the data. The record format 400 typically includes elements that correspond to units of data, such as a person's name, a street address, a payment amount, and so on. The record format 400 may be based upon, for example, iCalendar, which represents calendar entries, a microformat,or another defined data format. For example, a task record 138 in which the record format 400 is the iCalendar format may be represented as follows:

BEGIN:VCALENDAR
PRODID:-//XYZproduct//EN
VERSION:2.0
BEGIN:VEVENT
URL:http://www.web2con.com/
DTSTART:20051005
DTEND:20051008
SUMMARY:Web 2.0 Conference
LOCATION:Argent Hotel\, San Francisco\, CA
END:VEVENT
END:VCALENDAR.

As that example illustrates, the task record 138 is in one aspect a structured form of data that can be used to describe content. The corresponding content would be, for example, “Web 2.0 Conference: October 5-7, at the Argent Hotel, San Francisco, Calif.” Such a task record would create a calendar task named “Web 2.0 Conference” on the user's calendar on the dates October 5 through 7.

FIG. 5 is an illustrative diagram of a transactional calendar user interface 500 in accordance with some embodiments of the invention. The calendar interface 500 may show different views of a calendar, such as a day view that shows tasks on a particular day, a week view that shows tasks on the days of a particular week, and a month view that shows tasks on the days of a particular month. The month view is shown in FIG. 5. The calendar interface may be based on Yahoo!® Calendar, or the like.

A transactional calendar can be used to interact with online services that involve any type of tasks. The calendar's user interface 500 has features for choosing a service to invoke. When the calendar invokes the service, the date and time currently selected on the calendar are automatically passed to the service in a defined data format. Upon completing a task, the service returns the result to the calendar, possibly with a modified date, and the transactional calendar creates a calendar entry for the task. The calendar entry typically refers back to the task. In one aspect, the calendar entry appears as a link that the user can select to display details about the task.

For example, a user may wish to pick a date and buy tickets to go to the theater or for an airline flight. The user would click on the date, and the date would be automatically forwarded to a ticket reservation service. The date of the reservation would then be used to automatically add a task to the calendar for the reservation. Therefore a user's receipts are organized chronologically, as opposed to being stored in email messages or other locations that require explicit organizational effort by the user.

In one aspect, the transactional calendar may make inferences based upon tasks executed by a user. For example, if a user purchases movie tickets, makes dinner reservations, and pays for dry cleaning, then an inference could be made that the user has a date that night. In one aspect, the transactional calendar may automatically create one or more additional calendar entries based upon one or more tasks according to rules or heuristics. The rules or heuristics may use information such as a user's preferences, characteristics, demographics, and past tasks to generate new task entries. For example, the transactional calendar may have an inference engine or other rule-based system that generates new task entries based upon the task entries that a user has recently created. A rule may associate one or more types of trigger tasks with one or more inferred tasks. The rule may then be applied to each calendar entry or to sets of calendar entries to generate inferred tasks if the calendar entry matches the trigger task(s) associated with the rule. The rule may also include conditions based upon runtime values of options associated with the trigger task, so that a task would be inferred if the values of the calendar entry satisfy the condition. In one aspect, a calendar entry may be compared to a trigger task by comparing the task type 410 of the task record 400 of FIG. 4 to a task type associated with the trigger task. In another aspect, keywords in the description 416 of the task record 400 may be used to select trigger tasks. For that example, the transactional calendar may include a rule that if the triggering tasks of buying movie tickets, making a dinner reservation, and paying for dry cleaning all occur on the same day, then tasks to buy and play romantic music are to be generated.

In another example, a limited time promotional offer could be made to users who purchase certain items with a certain price by using a rule that automatically generates a promotional offer and adds it to the user's calendar if the user executes a trigger task with a purchase price greater than a certain value. As another example, when a user checks an item out of a library, the library system may generate a calendar entry specifying the return date of the item, and the transactional calendar would create a calendar entry for the due date, stating that the item is due. However, a user may wish to schedule a reminder prior to the due date. A rule could be defined with the library checkout task as the triggering task, and a reminder task two days before the due date as the inferred task, which would automatically be generated each time the user executes a library checkout task.

In one aspect, the transactional calendar may use data such as a user's current geographical location, the location of other events occurring on the specific day, the season of the year, holidays, and other information about the time and place associated with the user or with the task to infer additional tasks to be displayed or to influence the tasks that are displayed. For example, if the current month is December, and the user has an evening party event listed on their calendar, the transactional calendar may offer a season-appropriate or holiday-themed collection of hostess gifts for purchase.

In another aspect, the transactional calendar may generate suggestions based upon purchase events. The suggestions may be presented to the user for approval. If the user approves of a suggestion, the transactional calendar adds the suggested event to the user's calendar as a task. For example, if a user purchases tickets for a play at 8:00 PM at the Curran Theatre, the transactional calendar may use the time, 8:00 PM, and geo-spatial information, e.g., the location of the Currant Theatre, to offer available dinner reservations at restaurants close to the theatre. If the user likes one of the offerings, the transactional calendar can book the reservation and display parking options. By providing information about an initial set of tasks they intend to perform, a user can build a complete itinerary within the calendar based upon additional suggestions that the calendar makes based upon the initial set of tasks. In one aspect, a rule generates an inferred task based upon a time associated with the task record, and the difference between the time at which the inferred task occurs and the time associated with the task record is less than a predetermined threshold. The predetermined threshold may be determined by the user, or may be a constant value, such as 30 minutes or one hour.

The transactional calendar allows a user to work within a time-based view. The results of tasks may include receipts, which may be attached to the calendar entries for the tasks. The calendar-based format in combination with the automatic update of the calendar based on the results of online tasks results in a view of online tasks that is organized by date.

A first Monday day feature 502 of the calendar interface 500 displays calendar entries for Monday, Oct. 2, 2006. A “Received paycheck” calendar entry 506 displayed in the Monday feature 502 represents a bank account deposit task. With reference to the communication diagram of FIG. 1B, the “Received paycheck” calendar entry 506 may have been created by the transactional calendar when it received a task record 138 from the service 162 (case (a)). Alternatively, the calendar entry 506 may have been'created by the transactional calendar when it received task details 134 directly from a web browser 132 running on the client 130 (case (b)). In either case, a user may have selected the Add feature 504 and entered the details of the task, including the amount of the paycheck received. Typically, information that can be provided automatically by a service, such as a report of a bank deposit task, would be generated automatically by the service 162, and sent by the service 162 to the transactional calendar 122 in a task record 138.

The “Received paycheck” calendar entry 506 is displayed in the day feature 502, which corresponds to the date (October 2nd) on which the bank account deposit task occurred. The transactional calendar retrieves the date and time on which the task occurred (9:00 a.m. October 2nd) from the transactional record, and adds the calendar entry 506 to the day feature 502 for that date, at the time. The transactional calendar retrieves the text “Received paycheck” for the calendar entry 506 from the task record 138. The text may be retrieved from the description field and the task type field of the task record 138.

In one aspect, the “Received paycheck” calendar entry 506 is responsive to selection by a user. If the user selects the “Received paycheck” task entity 506, then the calendar user interface will display details (not shown) about the “Received paycheck” task. The details include the date and time the task was started, and, if the task has completed, the date and status of completion. The details may also include a link, retrieved from the task record 138, which refers to a web page related to the task. The link acts as a receipt, which the user can open to view the details of a previously submitted task.

The text “Done” in the calendar entry 506 is displayed by the transactional calendar interface to indicate that the task is complete. The transactional calendar interface displays the “Done” indicator if the received task record 138 indicates that the task has completed, i.e., is done. The service 162 that generates the task record 138, e.g., an online banking service, typically sets a completion indicator 426 in the task record to indicate that a task is complete. For this bank deposit task example, the bank deposit task record's completion indicator indicated that the task was completed successfully, so the Done status is displayed in the bank deposit calendar entry 506.

The first Monday day feature 502 also includes a “Buy Airline Tickets to NYC” calendar entry 508 at 12:00 pm on Monday, October 2. The calendar entry 508 represents a completed task in which the user purchased airline tickets. As in the “Received paycheck” calendar entry 506 described above, the “Done” text indicates that the task is complete.

The first Monday day feature 502 includes an Add feature 504, which a user can select, e.g., click on, to create a new task to be executed on the on the date in which the Add feature 504 is displayed (Monday, October 2 in this example). Other user interface features may provide alternative methods for the user to create a new task. For example, a user may right-click a mouse when the mouse cursor is within the boundaries of the first Monday day feature 502 to add a new task to be executed on that day. As another example, when a day is displayed in a week view or in a single-day view, a set of times may be displayed, e.g., a line for every half-hour interval. A user may then point the mouse at a particular half-hour interval and right-click. A menu (not shown) will then be displayed, and the menu will include an “Add” option (not shown) for adding a new task to be executed at the selected time on that day

The “Buy airline tickets to NYC” calendar entry 508 may have been created by the transactional calendar when it received a task record 138 from the service 162 (case (a)). Alternatively, the calendar entry 508 may have been created by the transactional calendar when it received task details 134 directly from a web browser 132 running on the client 130 (case (b)). In either case, a user may have selected the Add feature 504 and entered the details of the “Buy airline tickets” task, including the airport information and the travel dates. In case(a), the transactional calendar 122 sends the details of the task to the service 162, e.g., an airline reservation service, to perform the ticket reservation task. The service 162 would then respond by sending another task record 138 back to the transactional calendar 122 indicating any additional information, such as availability, success or failure of the reservation, and completion status of the reservation (e.g., pending or complete).

A Tuesday day feature 510 that represents October 3 includes a “Make hotel reservations in NYC” calendar entry 512 at 12:00 pm on October 3. The Tuesday day feature 510 also includes an “Outbound flight to NTC” calendar entry 514 at 2:30 pm on October 3. A Wednesday day feature 516 that represents October 4 includes a “Purchase scooter” calendar entry 518 at 3:00 pm on October 4. A Friday day feature 520 that represents October 6 includes a “Return flight from NYC” calendar entry 522 at 12:00 pm on October 6.

A second Monday day feature 524 that represents October 9 includes a “Scooter delivery date” calendar entry 526 at 11:00 am. The “Scooter delivery date” task occurs in the future, as shown by the “Future” indicator displayed in the calendar entry 526. The “Future” indicator is displayed when the completion status 426 of a task record 138 indicates that the task described by the task record 138 occurs in the future. The “Scooter delivery date” calendar entry was created by the transactional calendar in response to receipt of a task record 138 from the service 162 that indicated that the Scooter delivery date would be October 9.

A Thursday day feature 530 that represents October 26 includes a “Pay credit card bill” calendar entry 532 at 12:00 pm. The “Pay credit card bill” task occurs in the future, as shown by the “Future” indicator. The “Pay credit card bill” task was created in response to a client selecting an “Add” feature 534. The user entered the task details, including the description “Pay credit card bill,” the task type, a bank payment, and task options, such as the amount to be paid and the payment information for paying the bank that issued the credit card. The “Pay credit card bill” calendar-entry 530 may be executed automatically by the task calendar on October 26. That is, the transactional calendar may submit tasks to the corresponding service automatically, using the parameters specified in the task description. Alternatively, the calendar entry 530 may be a reminder that prompts the user to pay the bill, but does not actually perform the task.

In one aspect, tasks may be created using calendars of different users. For example, multiple users may share a calendar, so that when one user performs a task, the results are visible by all users of the calendar, or in calendars of other designated users.

Tasks may span multiple days. For example, if a user A goes to New York, the user A may have a hotel reservation actually made for five days in New York. The calendar has a task record indicating that the user A is in New York for those five days. If another user B requests that the user A come to a meeting, the transactional calendar may automatically generate a response indicating that user A cannot attend because she is in New York. Access control may be associated with the task entries to allow only certain users to access the task entries. For example, an access control attribute may be associated with a calendar, or with each task entries. An access control entry may specify that user B has permission to access, i.e., read, all of user A's task entries. In that case, the transactional calendar would inform user B that user A is in New York when user B requests a meeting with user A. However, if an access control entry specifies that user B does not have permission to access user A's task entries, then the transactional calendar may withhold all information about user A's location from user B, or may indicate that user A is not available on the requested date, without providing further details.

In the calendar view of tasks, the user can see their tasks in the form of time-based tasks. The tasks are automatically added to the calendar, and the user can view the tasks in a particular day, week, or month. The user may request a map view that shows the locations or venues of the tasks in a particular time period, such as a day or a week.

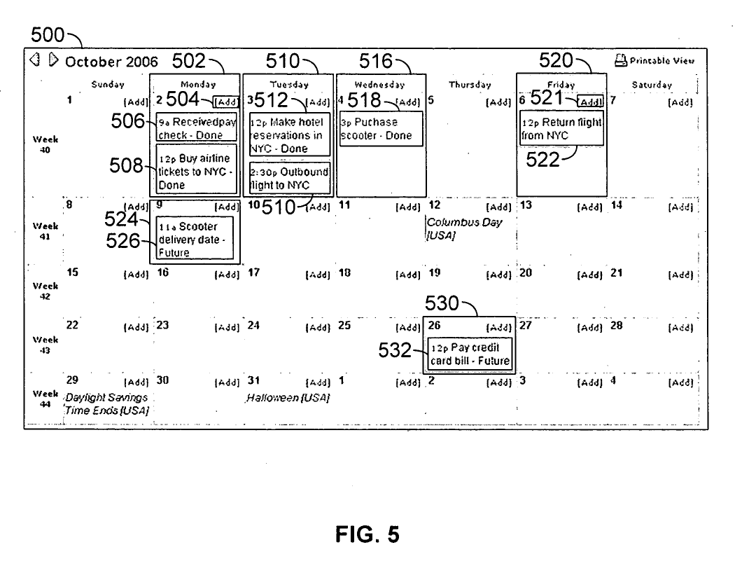

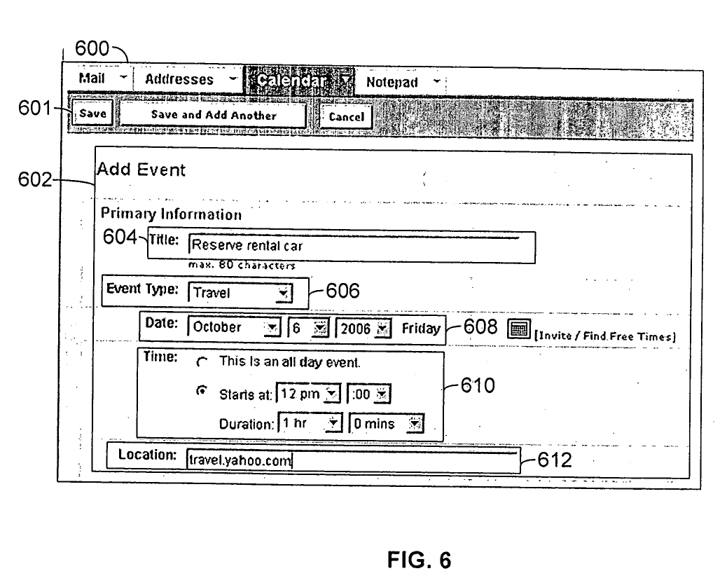

FIG. 6 is an illustrative diagram of a user interface 600 for invoking a car rental service from a transactional calendar in accordance with some embodiments of the invention. The user interface 600 includes an Add Task interface 602, which is displayed when a user selects an Add feature for a particular date, such as the Add feature 504 shown in FIG. 5. The Add Task interface 602 accepts information about a task provided by a user. The information includes a title 604, e.g., “Reserve rental car,”, a task type 606, e.g., “Travel,” a date 608, e.g., Oct. 6, 2006, a start time 610, e.g., 12:00, and a Location 612, which is typically a link to a web site of a service provider that can perform the task. For example, the travel.yahoo.com web site accepts the information shown in the Add Task 602 in a request to reserve a rental car. When the user clicks the Save button 601, the online calendar will submit a task record to the travel.yahoo.com service requesting a rental car reservation. The task record will contain the date associated with the selected Add feature, e.g., October 6, as well as a task type indicating that the task is a rental car reservation request. In response to receipt of the task record from the online calendar, the travel.yahoo.com service will display a data entry form which the user may complete to reserve a car. Portions of the data entry form will be filled in automatically with information from the task record, as described below with reference to FIG. 7.

FIG. 7 is an illustrative diagram of a car rental service-user interface showing dates provided by a transactional calendar in accordance with some embodiments of the invention. A Search for Cars form 700 is a user interface displayed by a rental car reservation service such the Yahoo!® Travel service accessible at the link travel.yahoo.com. The Search for Cars form 700 includes a pickup location 702, which allows a user to enter an airport or other location at which the car is to be picked up. The transactional calendar may, for example, fill in the pickup location 702 using a value from the options 220 of the task record 208 of FIG. 2. The transactional calendar may provide the value for the pickup location 702 in an HTTP message, or, if the travel.yahoo.com service accepts task records, in a task record. The Search for Cars form 700 also includes pick-up and drop-off dates 704. The transactional calendar may provide the values for the pick-up and drop-off dates 704 in an HTTP message or in a task record. The user need not enter at least one of the dates in the transactional calendar interface, e.g., the pick-up date, because the user selected a day, and possibly a time, on the calendar interface when selecting an Add feature 521 on the Friday, October 6 day, thereby indicating that the rental car reservation is to be added on Friday, October 6.

The search for cars form also includes a car type field 706, which the user may fill in when creating the reservation, or which may be filled in automatically from an option value in the task record sent by the transactional calendar to the service. The transactional calendar would include an option value in the transactional record if, for example, the calendar user has a default rental car type specified in his user preferences. Therefore, if sufficient user preferences are specified for the transactional calendar user, all of the fields in the Search for Cars form 700 of the car reservation service can be filled in automatically, with the possible exception of the duration of the rental. The pick up and drop off locations and the car type can be retrieved from the user preferences and sent to the car reservation service along with the selected pickup date in a task record.

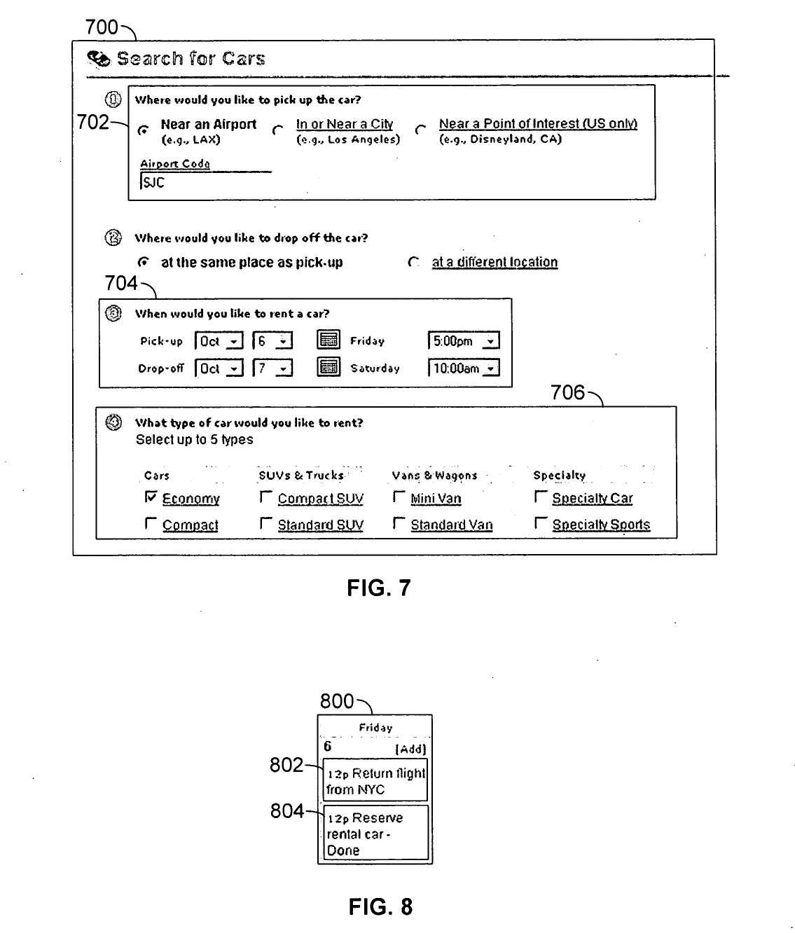

FIG. 8 is an illustrative diagram of a transactional calendar user interface showing a calendar item automatically made in response to a car reservation task in accordance with some embodiments of the invention. FIG. 8 shows an updated view of the Friday day 800. The Friday day feature 800, which corresponds to the Friday day feature 520 of FIG. 5, now includes a “Reserve rental car”calendar entry 804 at 12:00 pm on October 6. The “Reserve rental car” calendar entry 804 was added to the calendar after the user successfully completed a rental car reservation using the “Search for Cars” 'form 700 of FIG. 7. The rental car reservation is complete, as shown by the “Done” indicator in the calendar entry 804. The “Done” indicator indicates that the reservation has been made. An additional indicator such as “In Use” could be displayed to indicate that the rental car is in use. A calendar entry could automatically be added to the day on which the rental car is to be returned, to remind the user to return the car.

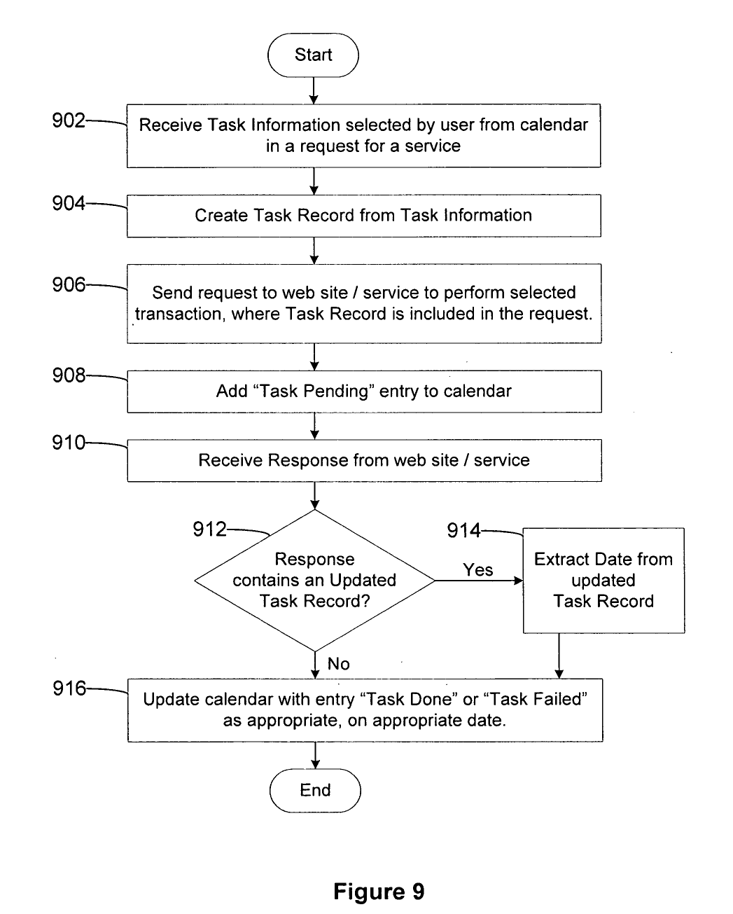

FIG. 9 is an illustrative flow diagram of a process in which a transactional calendar invokes an online service and is automatically updated based on the results in accordance with some embodiments of the invention. The flow diagram of FIG. 9 corresponds to case (a) described above, in which the transactional calendar invokes the service by sending a transactional record, and the service sends a response back to the calendar. The process begins at stop 902 by receiving task information selected by a user from a calendar interface. The task information is received in a request for a service. Block 904 creates a task record from the task information.

Block 906 sends a request to a web site or web service, which is typically identified based upon the task type, e.g., Make Credit Card Payment in the task record, possibly in combination with user preference information that indicates a specific site or service, e.g., the banks and account numbers to be used for the credit card payment. The web site or service may also be identified explicitly by the user, e.g., travel.yahoo.com. Block 906 includes the task record in the request, to specify the type of task, associated options, dates, user credentials, and other relevant information. The request is typically sent via a network such as the Internet, and contains the task record that describes the task requested by the user.

Block 908 adds a calendar entry to the calendar with the day and time specified in the task record. The calendar entry may be displayed with a “Pending” indicator to indicate that the task is still pending and a response has not been received from the web site or service. Block 910 receives a response from the web site or service. The response is typically received via a network such as the Internet. Block 912 determines if the response contains an updated task record. If the response contains an updated task record, block 914 extracts the date and any other updated values, such as task options, from the task record. Otherwise, execution contains at block 916. Block 916 replaces the “Pending” indicator displayed in the calendar entry with a “Done” indicator, or with a “Failed” indicator, if the error status in the task record indicates that the task failed.

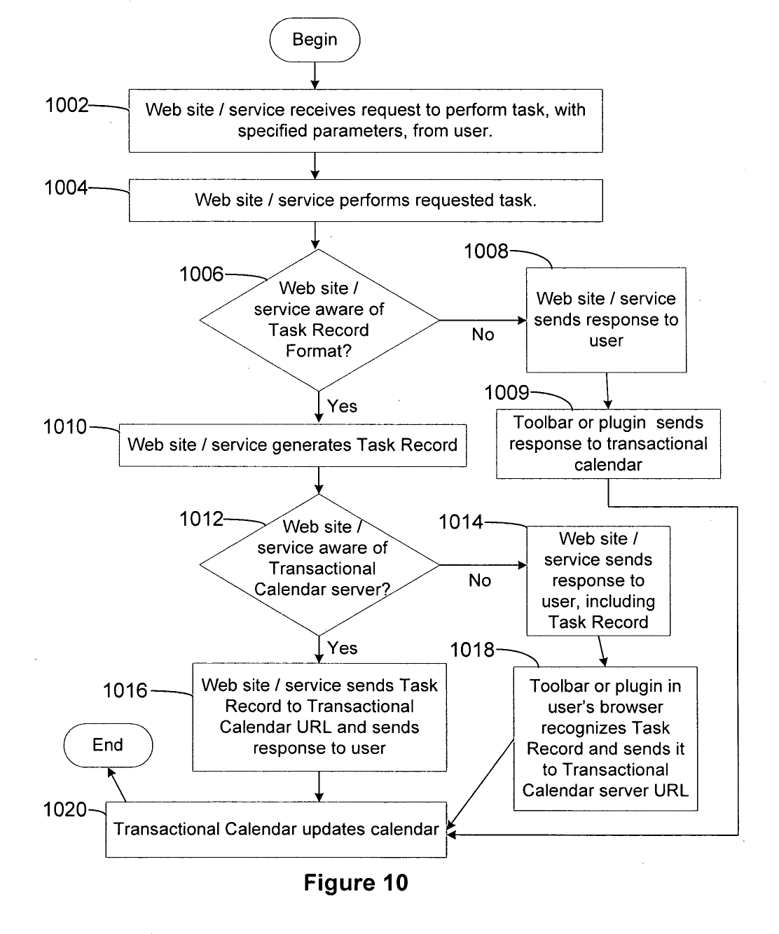

FIG. 10 is an illustrative flow diagram of a process in which a user invokes an online service and the transactional calendar is automatically updated based on the results in accordance with some embodiments of the invention. The flow diagram of FIG. 10 corresponds to case (b) described above, in which a service sends a task description to the transactional calendar.

At block 1002, a web site or service receives a request to perform a task, with options and parameters specified by the user. At block 1004, the web site or service performs the requested task. Block 1006 determines if the web site or service is aware of the task record format, i.e., if the web site or service is able to process task records. If not, at block 1008, the web site or service sends the response to directly to the user, and a toolbar or plugin running in the user's browser may recognize the response at block 1009, and pass the response to the transactional calendar URL, after which processing continues at block 1020, in which the transactional calendar updates the calendar by adding a task entry that represents the requested task. If the web site or service is aware of the task record format, the web site or service generates a task record that represents the requested task at block 1010.

In one aspect, web sites and services may support the task record format by recognizing task records as requests to create tasks and by generating task records when tasks finish executing. Web sites and services may lack support for the task record format, however. In such cases, the web sites and services may generate an email message or other reply, which may be parsed by the transactional calendar to generate a task record. In these cases, block 1006 determines that the web site or service is aware of the task record format.

In another aspect, web sites and services may support the task record format, but may not support sending results back to a transactional calendar service, or may not have the network address or name of the transactional calendar service. In such cases, block 1012 determines that the web site or service is aware of the task record format, and block 1012 determines that the web site or service is not aware of the transactional calendar server, and executes blocks 1014 and 1018. In block 1014, the web site or service sends a response to the user. The response includes a task record. In block 1018, a toolbar or plug-in running in the user's browser recognizes the task record and forwards it to the transactional calendar server. Control is then transferred to block 1020.

If block 1012 determines that the web site or service is aware of the transactional calendar server, then, in block 1016, the web site or service sends the transactional record directly to the transactional calendar's network address. The web site or service also sends a response to the user, since the user may expect information in the form provided by the web site or service. Finally, at block 1020, the transactional calendar updates the calendar interface view to include a calendar entry for the task that was just processed.

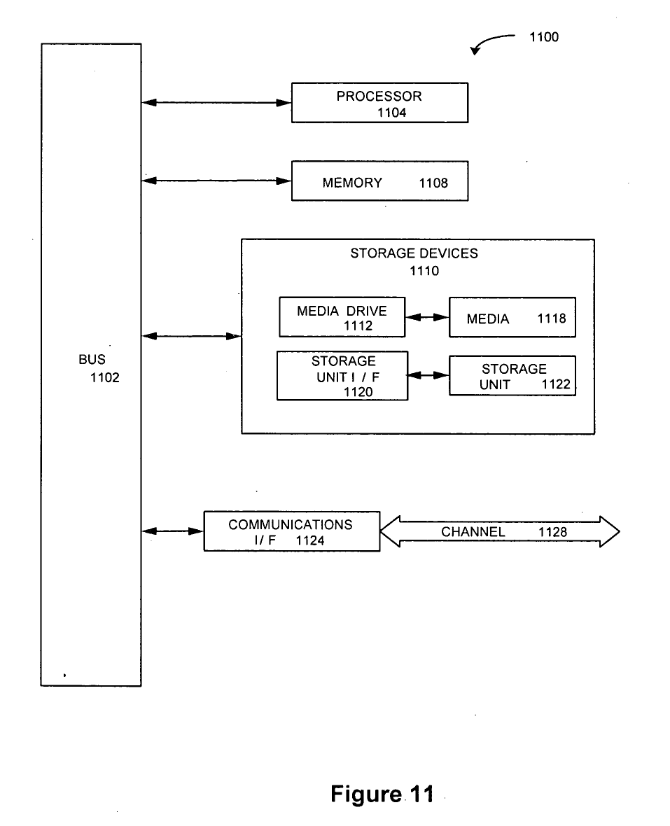

FIG. 11 is an illustrative drawing of an exemplary computer system that may be used in accordance with some embodiments of the invention. FIG. 11 illustrates a typical computing system 1100 that may be employed to implement processing functionality in embodiments of the invention. Computing systems of this type may be used in clients and servers, for example. Those skilled in the relevant art will also recognize how to implement the invention using other computer systems or architectures. Computing system 1100 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 1100 can include one or more processors, such as a processor 1104. Processor 1104 can be implemented using a general or special purpose processing engine such as, for example, a microprocessor, microcontroller or other control logic. In this example, processor 1104 is connected to a bus 1102 or other communication medium.

Computing system 1100 can also include a main memory 1108, such as random access memory (RAM) or other dynamic memory, for storing information and instructions to be executed by processor 1104. Main memory 1108 also may be used for storing temporary variables or other intermediate information during execution of instructions to be executed by processor 1104. Computing system 1100 may likewise include a read only memory (“ROM”) or other static storage device coupled to bus 1102 for storing static information and instructions for processor 1104.

The computing system 1100 may also include information storage system 1110, which may include, for example, a media drive 1112 and a removable storage interface 1120. The media drive 1112 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 1118, may include, for example, a hard disk, floppy disk, magnetic tape, optical disk, CD or DVD, or other fixed or removable medium that is read by and written to by media drive 1114. As these examples illustrate, the storage media 1118 may include a computer-readable storage medium having stored therein particular computer software or data.

In alternative embodiments, information storage system 1110 may include other similar components for allowing computer programs or other instructions or data to be loaded into computing system 1100. Such components may include, for example, a removable storage unit 1122 and an interface 1120, such as a program cartridge and cartridge interface, a removable memory (for example, a flash memory or other removable memory module) and memory slot, and other removable storage units 1122 and interfaces 1120 that allow software and data to be transferred from the removable storage unit 1118 to computing system 1100.

Computing system 1100 can also include a communications interface 1124. Communications interface 1124 can be used to allow software and data to be transferred between computing system 1100 and external devices. Examples of communications interface 1124 can include a modem, a network interface (such as an Ethernet or other NIC card), a communications port (such as for example, a USB port), a PCMCIA slot and card, etc. Software and data transferred via communications interface 1124 are in the form of signals which can be electronic, electromagnetic, optical or other signals capable of being received by communications interface 1124. These signals are provided to communications interface 1124 via a channel 1128. This channel 1128 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 1108, storage device 1118, or storage unit 1122. These and other forms of computer-readable media may be involved in storing one or more instructions for use by processor 1104, to cause the processor to perform specified operations. Such instructions, generally referred to as “computer program code” (which may be grouped in the form of computer programs or other groupings), when executed, enable the computing system 1100 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 1100 using, for example, removable storage drive 1114, drive 1112 or communications interface 1124. The control logic (in this example, software instructions or computer program code), when executed by the processor 1104, causes the processor 1104 to perform the functions of the invention as described herein.

The methods disclosed herein allow a user to scan tables of numbers and quickly identify the important information. Aggregating and visually highlighting the streak information provides information that is not readily available in existing statistics displays.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

1. A computer-enabled method of adding a task to an online calendar, comprising the steps of:
receiving selection of a date from a user of the online calendar;
receiving selection of a task type from the user; and
adding a calendar entry to the online calendar, wherein the calendar entry includes the date and the task type.

2. The method of claim 1, further comprising the steps of:
sending a request to a server to execute an operation, wherein the request is based upon the task type and the date,
wherein the server is selected based upon the task type, and the request includes the task type and the date;
receiving a response from the server; wherein the response includes a result; and
adding the result to the calendar entry.

3. The method of claim 2, wherein the response includes a link to a web page associated with the task, further comprising the step of:
adding the link to the calendar entry.

4. The method of claim 1, further comprising the steps of:
generating an inferred task based upon a rule, wherein the rule is chosen based upon the task type and the date, and the rule generates the inferred task based upon the task type and the date; and
adding the inferred task to the calendar.

5. The method of claim 4, wherein the difference between a first time value at which the inferred task occurs and a second time value included in the date is less than a predetermined threshold.

6. A transactional calendar, comprising:
a calendar day feature for displaying a calendar, wherein the calendar day feature comprises an add task feature for creating a new task, and the calendar day feature is operable to display a calendar entry that represents an existing task;
date selection logic for receiving selection of a selected calendar date;
task selection logic for receiving selection of a task type and a task option parameter for the task type;
task record generation logic for generating a task record, wherein the task record is based upon the task type, the calendar date, and the task option parameter; and
task submission logic for sending the task record to an online service.

7. The transactional calendar of claim 6, further comprising:
update receiving logic for receiving a task processing update, wherein the task processing update comprises a task record, and wherein the task record comprises a date and a completion status; and
update display logic for displaying the completion status in the calendar entry,
wherein the update display logic is operable to display the task processing update in the calendar entry.

8. The transactional calendar of claim 7, wherein the task processing update comprises a link to a web page for the task, and
wherein the update display logic is operable to display the link in the calendar entry as a hyperlink to the web page.

9. The transactional calendar of claim 6, wherein the task record further comprises security credentials of the user.

10. A computer-enabled method of updating an online calendar with information describing a task, in response to execution of the task by an online service, the method comprising the steps of:
receiving a task record from the online service,
wherein the task record includes a task date; and
adding a calendar entry to the online calendar,
wherein the calendar entry is associated with a calendar date, the calendar date is associated with the online calendar, the calendar date is based upon the task date, and the calendar entry includes a description of the task.

11. The method of claim 10, wherein the task date comprises a date of execution of the task, a date of a reservation referenced by the task, or a combination thereof.

12. The method of claim 10, wherein the task record further comprises a completion status, further comprising the step of:
adding the completion status to the calendar entry,
wherein the completions status comprises a pending status and a completed status.

13. The method of claim 10, wherein the task date specifies the time of completion of the task.

14-15. (canceled)

16. A computer-enabled method of updating an online calendar with information describing a task, in response to execution of the task by an online service, the method comprising the steps of:
receiving a task record from the online service; and
adding an entry to the online calendar, wherein the entry includes a date, a task type, and a result extracted from the task record.

17. The method of claim 16, wherein the method is to be executed by a toolbar component of a client browser.

18. A computer-readable medium comprising instructions for adding a task to an online calendar, the instructions for causing performance of a method comprising the steps of:
receiving selection of a date from a user of the online calendar;
receiving selection of a task type from the user; and
adding a calendar entry to the online calendar, wherein the calendar entry includes the date and the task type.

19. The computer-readable medium of claim 18, the method further comprising the steps of:
sending a request to a server to execute an operation based upon the task type and the date,
wherein the server is selected based upon the task type and the request includes the task type and the date;
receiving a response from the server; wherein the response includes a result; and
adding the result to the calendar entry.

20. The computer-readable medium of claim 18, the method further comprising the steps of:
generating an inferred task based upon a rule, wherein the rule is chosen based upon the task type and the date, and the rule generates the inferred task based upon the task type and the date, and
adding the inferred task to the calendar.

21. The computer-readable medium of claim 20, wherein the difference between a first time value at which the inferred task occurs and a second time value included in the date is less than a predetermined threshold.

22. A system comprising the computer readable medium of claim 18, and further comprising a processor for executing the instructions.
